(19) United States
(12) Patent Application Publication
(10) Pub. No.: US 2008/0125261 A1
(43) Pub. Date: May 29, 2008

(54) Inner ATV Sprocket Guard

(76) Inventor: Lazarus Sommers, Millersburg, OH (US)

Correspondence Address: LAZARUS SOMMERS, 6748 TR 630, MILLERSBURG, OH, 44654, US

(21) Appl. No.: 11/564,817

(22) Filed: Nov. 29, 2006

(51) Int. Cl. B62J 13/00

(52) U.S. Cl. 474/144

(57) ABSTRACT

An inner ATV sprocket guard that is larger in diameter then the sprocket and mounts to the same rotating assembly as the sprocket and mounts close to the chain providing additional protection for the sprocket and aids in guiding the chain onto the sprocket.

### BACKGROUND OF THE INVENTION

In the past a few companies used an outer sprocket guard to protect the chain, sprocket, and to help guide the chain onto the rear sprocket on ATVs.

With the past setup, there was still an issue with damage to the sprocket and chain derailment on the inside of the sprocket.

The present invention is an inner sprocket guard for the rear of an ATV that attaches to the rotating assembly to help protect the sprocket and to help avoid chain derailment.

### SUMMARY OF THE INVENTION

The inner sprocket guard for an ATV is an improvement in protection for the rear sprocket on an All Terrain Vehicle, also known as an ATV, Quad, or 4 wheeler just to name a few names.

Outer sprocket guards have been around for many years on ATVs and inner sprocket guards have been used in go-kart racing and micro sprint racing for many years.

What the inner sprocket guard is, is a circular plate that bolts to the rotating assembly inside of the sprocket, has a larger diameter the sprocket and is very close to the chain.

What the inner sprocket guard does, is help guide the chain onto the sprocket and provide a surface for rocks and other debris to hit before they hit the rear sprocket.

Other applications have used this design in the past but the difficulty of installing an inner guard on an ATV due to the close tolerances verses the ease of installing a lower stationary skid plate have discouraged people from designing an inner sprocket guard until this invention.

The 3 key points in making this invention work are: The diameter of the guard being larger then the sprocket diameter with the chain installed on it, the guard being installed very close to the chain on the inboard side of the sprocket, and the guard being installed to the rotating assembly that the sprocket is attached to.

The attached drawings of ATV inner sprocket guards are only examples of this invention. This invention is in no way limited to these drawings and examples.

### BRIEF DESCRIPTION OF DRAWINGS

FIG. 1 is a side view of an inner ATV sprocket guard for a Honda TRX450R.

FIG. 2 is a end view of an inner ATV sprocket guard.

FIG. 3 is a drawing of an inner ATV sprocket guard installed on an ATV.

FIG. 4 is a drawing of an exploded view of one way to install an inner ATV sprocket guard.

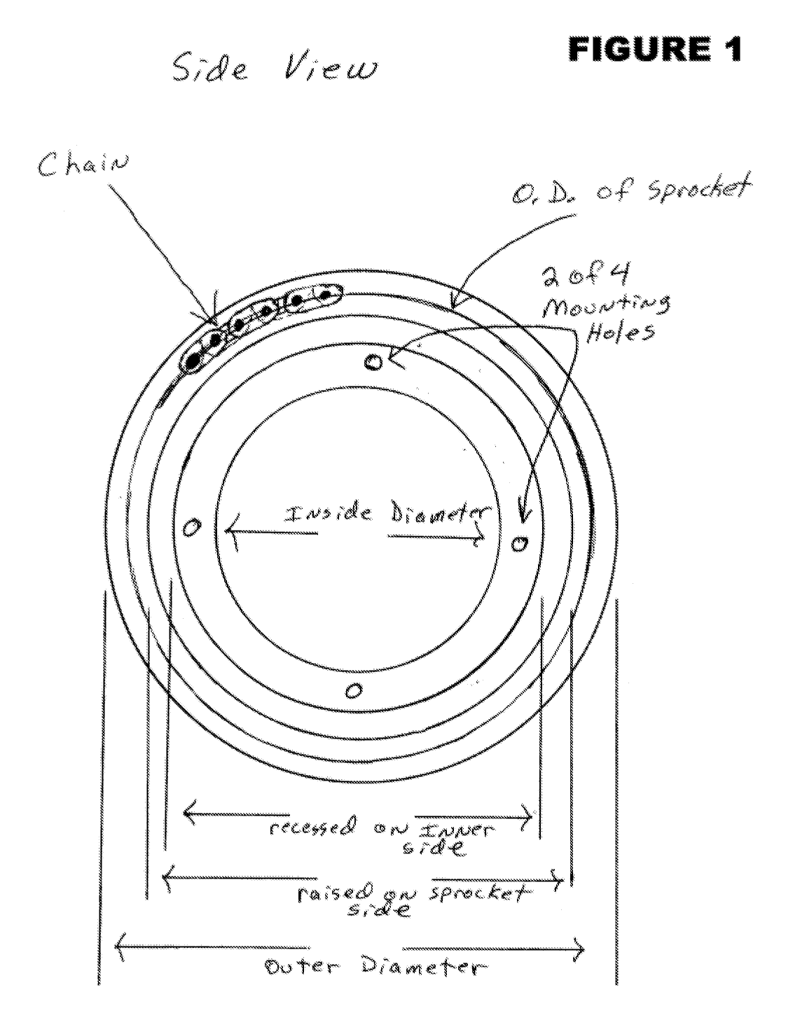

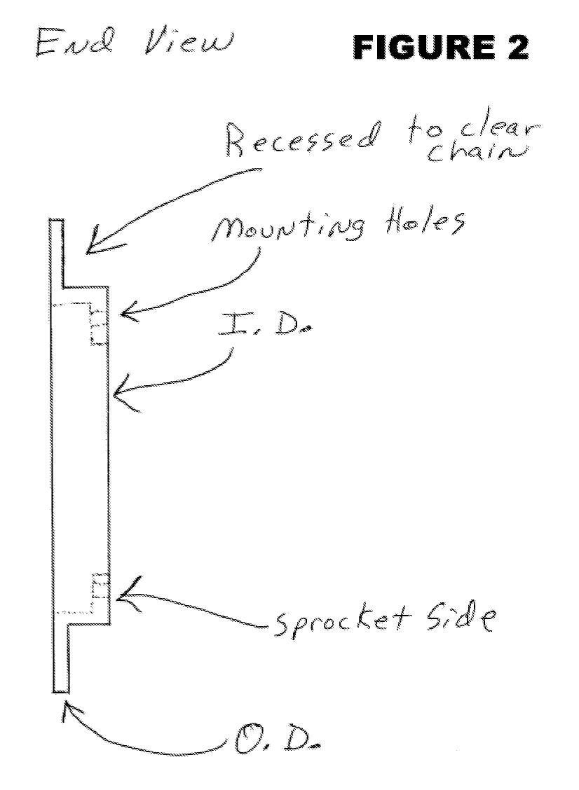

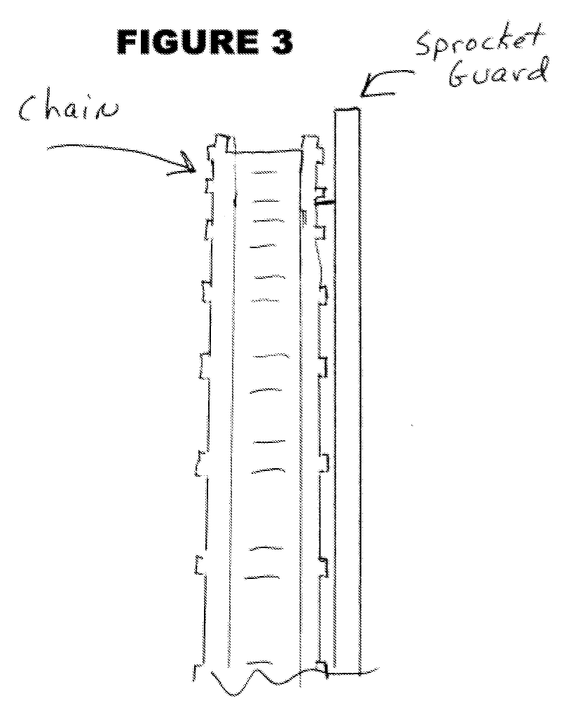

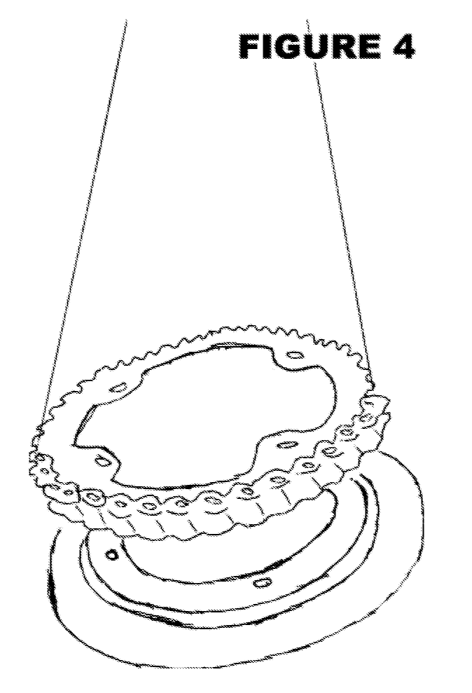

FIGS. 1, 2, 3, and 4 are only examples of this invention applied to an ATV. This invention is in no way limited to the applications used for examples.

What is claimed is:

1. A inner ATV sprocket guard that is larger in diameter then the sprocket.

2. A sprocket guard of claim 1 that attaches to the same rotating assembly as the sprocket.

3. A sprocket guard of claim 1 that attaches close to the chain.
